(19) United States
(12) Patent Application Publication
(10) Pub. No.: US 2007/0050488 A1
(43) Pub. Date: Mar. 1, 2007

(54) Broadcast with private reply control in a real-time messaging system

(76) Inventors: Wilbert R. Joyner JR., Raleigh, NC (US); Bethany Lyn Kessen, Austin, TX (US); Lorin Evan Ullmann, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/217,937

(22) Filed: Sep. 1, 2005

(51) Int. Cl. G06F 15/173

(52) U.S. Cl. 709/223

(57) ABSTRACT

A system and method for controlling the flow of reply messages cooperative with a multi-party Instant Messaging or chat service including a multi-party IM/chat group primary message having a text portion, a primary author indication portion, a blind-copy recipient list, wherein the blind-copy recipient list contains a plurality of recipients for the primary message; a demultiplexer for converting the primary message into a plurality of reduced multi-party messages, wherein each of the reduced multi-party messages are addressed to a sub-group of the blind-copy recipient list; a message submitter for submitting the reduced multi-party messages to an IM/chat service; a multiplexer which receives a plurality of reduced multi-party reply messages from the IM/chat service; and a reply message generator for extracting reply message text from the received reduced-party reply messages, and for generating a unitary simulated multi-party reply message containing the extracted reply message text for display to the primary author.

### INCORPORATION BY REFERENCE

The following publications are incorporated herein by reference in their entireties (where <dot> indicates a period or dot character “.”):
(a) “IBM Redbook: Working with the Sametime Community Server Toolkit”, published by International Business Machines, ISBN 0738423912, January, 2003, at ibm<dot>com/redbooks.
(b) “Introducing the Sametime Community: A Lotus Software White Paper”, published by Lotus Software, June 2003.
(c) “Use the Event Catalog in the IBM Common Event Infrastructure: Integrating event management across business and IT systems”, published by International Business Machines on Apr. 7, 2005, at http://www-128<dot>ibm<dot>com/developerworks/library/ac-catalog.
(d) “Chapter 23 Developing an Instant Messaging Architecture”, published by Sun Microsystems on http://docs<dot>sun<dot>com/source/819-0063/im-architecture.html.

### BACKGROUND OF THE INVENTION

1. Field of the Invention

This invention relates to technologies for providing and managing real-time or “instant” messaging services, and for providing online “chat” groups or rooms.

2. Background of the Invention

Chat rooms, chat groups, and Instant Message buddy lists are widely used in business and private lives today.

Generally, the organization of systems shown in FIG. 4 is implemented, where a plurality of client devices (41, 42, 43, 44) are interfaced by one or more computer or communication networks (45, 45′, 45″, 45′″) to one or more real-time or chat messaging servers (46), such as an International Business Machines™ (“IBM”) SameTime™ server, America Online's™ (“AOL”) Instant Messenger (“IM”), or similar system. These systems in their present forms are well known in the art. The server (44) acts a reflector to forward or copy messages to all of the chat group members each time a new message is received from a group member. The client devices, such as a Personal Digital Assistant (“PDA”), personal computer (“PC”), or smart wireless telephone, are equipped with a chat or IM agent which allow each group member to receive messages and view them, as well as to author replies or new messages within certain groups.

Using the currently available technology, a user can conduct multiple individual “chats” with multiple other users simultaneously and in approximately real-time, or the user can conduct a group chat where all members can see all response. For example, the message flow diagram shown in FIG. 6 shows a first message (61) “Can you send me your status?” being authored by a first client (41), which is received by the server (46). The server (46) then “instantly” sends copies of the message (61′, 61″, 61′″) to each of the other client devices (42, 43, 44). In this example, the third client (43) responds or replies first by sending a second message (62) back to the server (46), which then sends copies of the second message (e.g. first reply) (62′, 62″, 62′″) to all other clients (41, 42, 44) in the chat or IM group. At some time later in this example, the second client (42) also replies to the first message (61′), which involves the third message (e.g. second reply) (63) being sent to the server (46), and then being copied or forwarded (63′, 63″, 63′″) to all other clients in the chat or IM group (41, 43, 44). In this manner, every message sent into the server for a certain group of clients is copied or forwarded to every other member (except the authoring member) in the group. The author's message is typically added to the thread display by the local client software, but may alternately be reflected by the server back to the author to provide a more positive indication of its distribution.

One drawback to this system, however, it that there is no way to have a “blind copy” chat with multiple people, wherein a first user can easily broadcast the same message to multiple members of a group, but control the reply message flow such that the replies are only received by the first user and not by the other members (e.g. the replies are not broadcast to the other members).

For example, some managers and project lead engineers like to use real-time messaging to ask questions from their group of employees or project team members. But, they may not desire for everyone in the group to see each others' responses, either for confidentiality purposes, or because they to not want to disturb the members except for the receipt of the broadcast message.

To accomplish this while taking advantage of the near-real-time nature of the IM or chat messaging systems, a manager can initiate multiple chat groups where each group actually only consists of two members—the manager and one member of his or her group. Then, the manager can manually send, often using a cut-and-paste operation in an IM user interface, the same message to each of the group members via a separate chat or IM group, as shown in FIG. 9. In this small group example of just four members plus the manager, the manager has opened four different instances of the IM user interface (91, 92, 93, 94), each of which is addressed to a different team member but which contains a manually reproduced copy of the manager's message. This will result in for different return messages, each in their respective user interface instances, which is clumsy and inefficient for the manager to use, especially for larger group sizes and/or for chats involving more than just a few messages and replies.

Another example of a need for real-time message broadcasting with private reply controls would be a polling operation, such as a marketing company or political polling organization, who would need to broadcast an identical message to a group of recipients, but who would want the replies to only be sent to the originator of the broadcast, and not to all of the other group members.

So, as just described, a user may utilize an IM or chat group system in a typical “many-to-many” fashion, as shown in FIG. 7a, wherein one group is formed and every member in the group sees every message (new and replies) posted from any member, or confidentiality can be controlled by initiation by a primary group member (44) of multiple “one-on-one” groups (71, 72, 73), each of which only consists of the primary group member (e.g. a manager, group leader, dialogue or meeting facilitator, intermediary deal broker, negotiator, poll taker, etc.) and one other group member.

Thus, no available technology for IM, real-time, or chat messaging provides a one-to-many and many-to-one communications capability which would allow a primary user to send a unitary message to a plurality of group members, to control whether or not replies from those group members are distributed to the other members or not, and to receive a consolidated, unitary reply message from those group recipients.

### SUMMARY OF THE INVENTION

The present invention provides a “Broadcast with Private Reply” system and method for cooperation with a real-time, “instant” or chat group system, which allows a primary user to designate whether or not replies to a message are distributed to all other members of a group, or whether those replies are only delivered to the primary member (e.g. the author of the message to which a reply is sent).

Alternate embodiments allow a user to select whether replies are delivered and displayed instantly as soon as they are transmitted by the replying party(ies), or to have all of the replies collected over a period of time and displayed in a consolidated, single reply message.

Another embodiment allows for the user to reply to the sequence of replies as they were received, and to optionally receive a report regarding which parties have replied and which have not.

The invention is suitable for implementation alternatively as code modifications to existing server products, such as Instant Messaging platforms, enterprise transaction processing systems, online transaction processors, and event-based messaging systems. Alternatively, the invention may be realized as functional extensions, such as “plug-ins”, for such systems, or for client-side components such as web browsers and instant messaging clients.

### BRIEF DESCRIPTION OF THE DRAWINGS

The following detailed description when taken in conjunction with the figures presented herein provide a complete disclosure of the invention.

FIG. 1 illustrates a user interface according to the invention for controlling the new real-time messaging with private reply control invention.

FIGS. 2a and 2b show a generalized computing platform architecture, and a generalized organization of software and firmware of such a computing platform architecture.

FIG. 3a sets forth a logical process to deploy software to a client in which the deployed software embodies the methods and processes of the present invention.

FIG. 3b sets forth a logical process to integrate software to other software programs in which the integrated software embodies the methods and processes of the present invention.

FIG. 3c sets forth a logical process to deploy software to a client via a virtual private network, in which the deployed software embodies the methods and processes of the present invention.

FIG. 4 illustrates a typical IM or chat server topology of components.

FIG. 5 provides a more detailed view of a typical IM or chat server system.

FIG. 6 shows a message protocol diagram for distribution of messages in a typical chat or IM system.

FIGS. 7(a) and 7(b) illustrate with signal flow diagrams two methods discussed for communication within one large group, or a number of manually created two-party groups.

FIG. 8 shows a message protocol diagram for distribution and handling of messages according to the present invention.

FIG. 9 depicts a conventional method of using multiple, individual chat or IM group instances to control the flow of reply messages.

FIG. 10 provides a functional block diagram of the invention.

FIG. 11 illustrates a client-side embodiment of the present invention.

FIG. 12 shows details of BPRC IM/chat messages with embedded controls according to the present invention.

FIG. 13 shows a user interface having a consolidated, simulated multi-party reply message according to the invention.

FIG. 14 provides details of a logical process according to the invention.

FIG. 15 shows an example user interface for repeating the BPRC IM/chat process of the present invention.

FIG. 16 shows details of an enhanced BPRC IM/chat message with embedded controls in which sub-groups are indicated.

FIG. 17 illustrates a server-side embodiment of the present invention.

### DESCRIPTION OF THE INVENTION

The present invention provides a broadcast with private reply control (“BPRC”) capability to an instant, real-time, or chat messaging system which extends the typical functions of the system beyond the typical ability to send and receive messages, and to add and delete members or other users to and from a “group” or “chat room”. The extended functionality allows a primary user (e.g. a message author or topic initiator) to designate whether or not replies to a message authored by the primary user and submitted into the group should be automatically distributed to all other members of the group, or if those replies should only be sent to the primary member. This allows the primary user to leverage the “instant” or real-time nature of such systems, as opposed to the slower or queued-type of schemes employed by electronic mail (“email”) systems, while enjoying greater control over the distribution of messages similar to that of email systems, all consolidated in a single user interface instance.

Suitable Messaging System

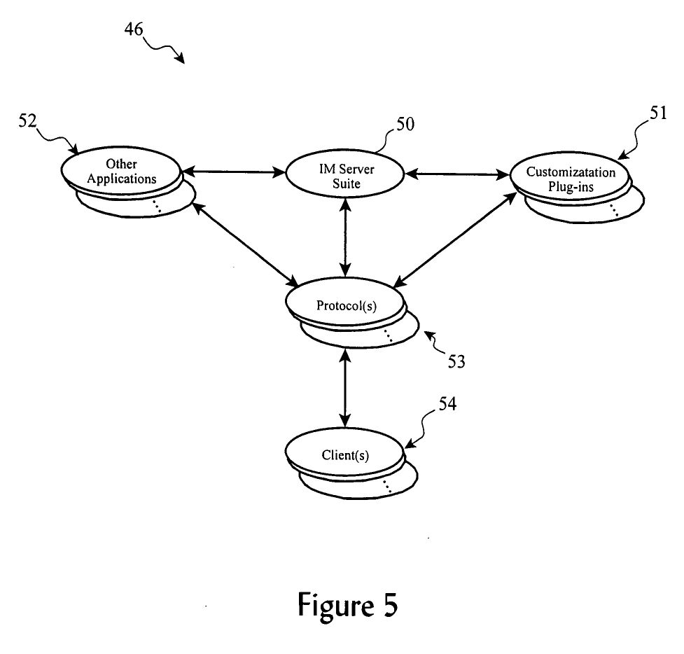

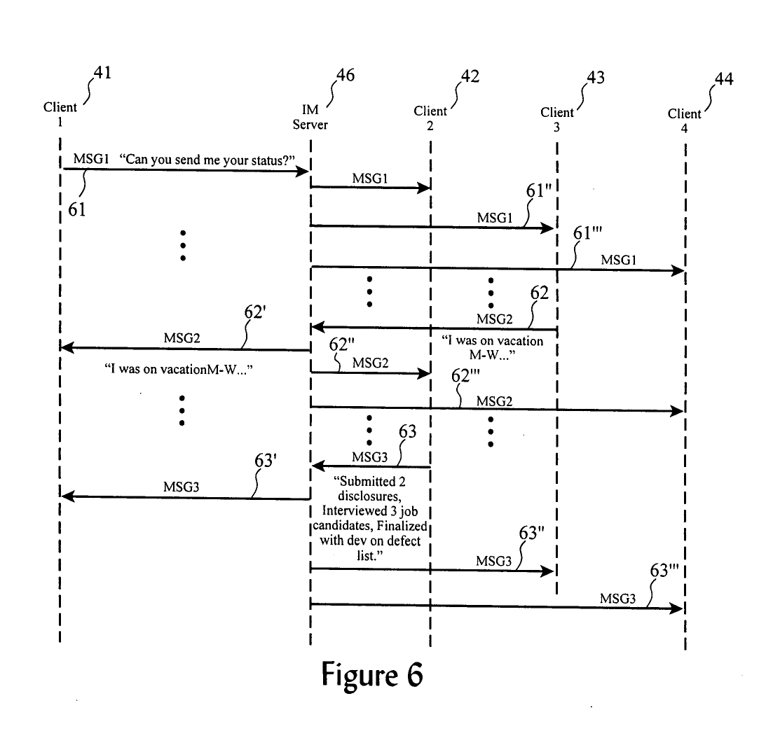

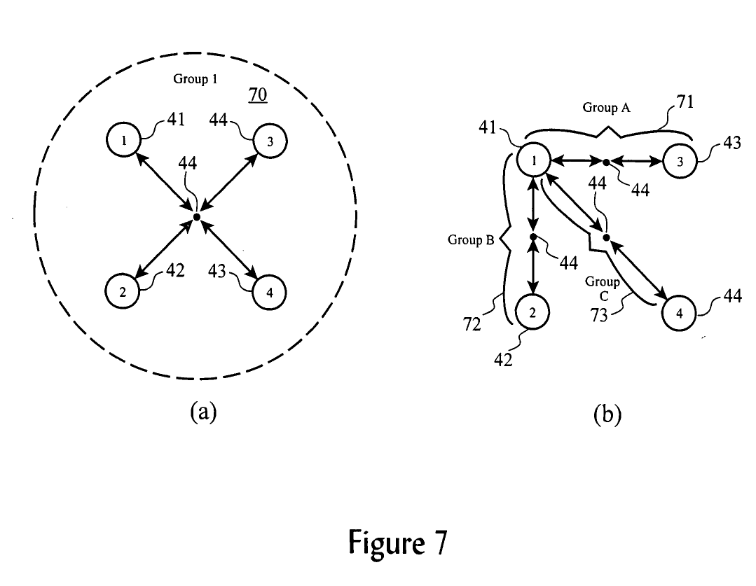

According to a preferred embodiment of the invention, the logical processes and functions of the invention are realized to cooperate with an existing client system, such as an IM client or chat client, to cooperate with an existing IM or chat server system, or a combination of both. In one available embodiment, as shown in FIG. 5, a well-known IBM SameTime™ message suite (50) is extensible by addition of protocols 953), plug-ins (51), or applications programs (52). As such, the invention may be realized in such extensions so as to provide additional functionality to one or more client devices (54) and users according to the following description.

Alternate embodiments may include implementations in conjunction with enterprise transaction operating environments, online transaction processing (“OLTP”) systems, and event-based messaging products, such as, but not limited to, IBM's Customer Information Control System (“CICS”), IBM's WebSphere MQ™, IBM's Common Event Infrastructure (“CEI”).

Other products and platforms from other suppliers for instant messaging, event handling, transaction processing, or application serving, may be employed in alternate embodiments, as well. For example, the present invention is particularly well suited to employ directory and channels in instant messaging, such as those provided by the Sun Microsystems IM Architecture.

Messaging Protocol

In the present disclosure, the term “broadcast with private reply”, or “BPRC”, shall be used to mean that when the recipient of a message from a primary user posts a reply message into a chat or IM group, the reply message is only sent to the primary user (e.g. a “private reply”), and it is not sent to the other group members. Traditional email systems as well as conventional instant messaging systems lack a control such as this, in which the sender of a message, not the recipient, can restrict the flow of reply messages.

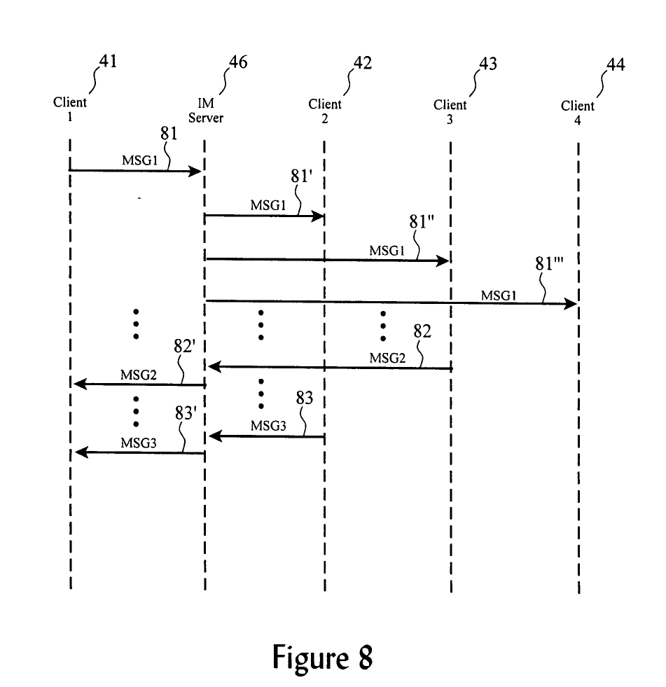

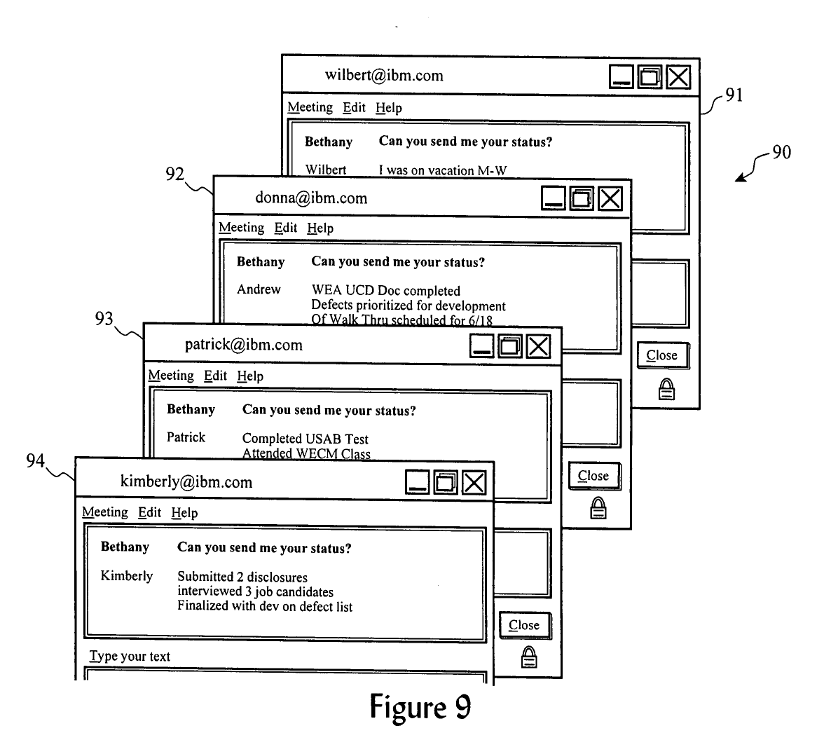

Turning to FIG. 8, a messaging protocol realized by the present invention is illustrated using an example relative to the previous examples. When a primary user (e.g. a first client) sends a specially-controlled “Broadcast with Private Reply” (81) to a number of members of a group (42, 43, 44), it is first received by the server (46), which then forwards copies (81′, 81″, 81′″) of the message to each recipient group member (42, 43, 44), respectively.

When a recipient, such as the third client (43) replies to the message, the reply message (82) is received by the server (46), which then forwards the reply message (82′) only to the primary user (41), and not to the other group members (42, 44). The reply message is preferably shown to the sender, e.g. the third client (43), as well, either by keeping a copy local to the client, or by sending a copy back to the third client.

The example of FIG. 8 also shows a second client (42) replying to the broadcast message, in which the replies (83, 83′) are only sent to the primary user (41), but are not sent to the other group members (43, 44), except for preferably showing the reply to the second client (e.g. the replying party).

Thus, in this manner, the replies to the original or initial message are blocked by the invention from being propagated to any other users except the user who broadcast the initial message.

BPRC IM/Chat Multiplexing/Demultiplexing

In order to accomplish this functionality, one embodiment of the invention provides that the basic IM server code is changed to offer the new functionality as described herein.

However, it is also desirable to realize a product or system which is interoperable with existing IM/Chat clients and servers in order to maintain full backwards compatibility with the installed base of millions of users and thousands of servers.

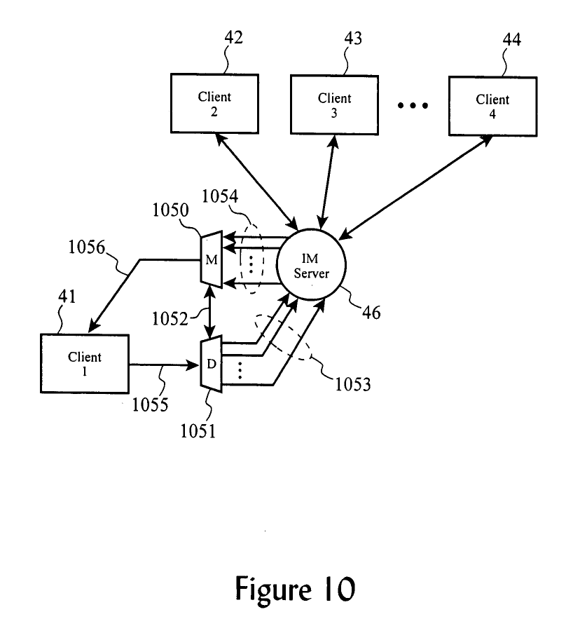

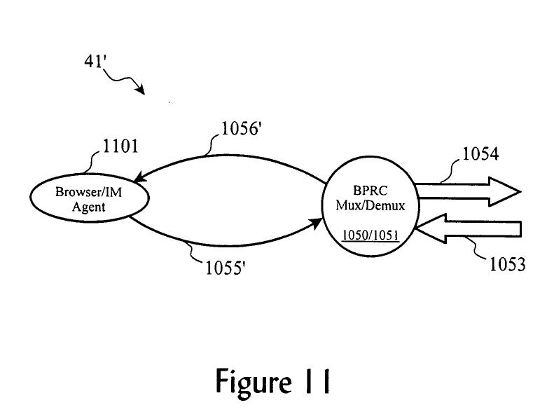

Therefore, a system as shown in FIG. 10 is another available embodiment of the present invention, in which the primary user's IM/chat client (e.g. client 1) (41) is provided with a demultiplexer (1051) for outbound BPRC messages, and a multiplexer (1050) for inbound BPRC messages, both of which cooperate (1052) with each other as described in the following paragraphs.

In this configuration, when the primary user authors a new IM/Chat message and designates it as a BPRC message, the unitary message (1055) is intercepted during transmission by the demultiplexer (1051), which then automatically submits multiple copies (1053) of the message into a plurality of one-on-one chat or IM groups being handled by the IM server (46).

The IM server then can route the messages (1053) within the two-party groups as previously described and as traditionally handled to the other clients (42, 43, 44) in the BPRC group, such that the core engine of the IM server may remain unchanged. Thus, what appears to the primary user as a unitary message into a multi-party group is transparently converted into multiple messages into a plurality of two-party groups, each client (42, 43, 44) being paired in a two-party group with the primary user (41).

As each of the parties (42, 43, 44) replies within their respective two-party group, a plurality of messages (1054) in a plurality of two-party groups are sent from the server (46) towards the primary user (41), but are intercepted by the multiplexer (1050).

According to one embodiment of the invention, these reply messages are associated upon receipt with the appropriate BPRC group as indicated by the demultiplexer, and are then “streamed” or forwarded in real-time to the primary user.

According to an alternate embodiment of the invention, the multiplexer collects these replies (1054) from a number of two-party groups over time, and associates them with the BPRC group as indicated by the demultiplexer (1051), preferably by a combination of time (e.g. within a certain number minutes, hours or days of the original message (1055)), topic, original message content, session ID, window or GUI instance, etc. In this alternate embodiment, after the replies (1054) have been collected by the demultiplexer (1050), they are combined into a unitary message (1056) and presented to the primary user (41) as if it were a unitary message in a multi-party IM/chat group, not a collection of messages from multiple two-party groups.

However, because transmission was actually handled as a number of two-party groups, none of the replies are allowed to be transmitted to the other parties in the BPRC group, except the primary user (41), in either embodiment.

In an embodiment hybrid of the two foregoing embodiments, the primary user is allowed to choose between streaming or real-time reply receipt, or waiting for a consolidated reply, as the former provides faster replies but may cause repeated graphical user interface updates, and as the latter provides for more efficient GUI refreshes but is less immediate in providing the primary user with the earlier replies.

In another embodiment, the primary user is provided with an option to “replay” the sequence of received messages. According to yet another embodiment, a report is generated to the primary user showing which recipients replied and which did not.

In this manner, by providing the demultiplexer and multiplexers cooperative with a number of two-party IM/chat groups, the primary user (41) is allowed to author a message, and to receive reply messages just conveniently as if the group were being handled as a unitary, multi-party IM/chat group, while maintaining control on the distribution of the replies to the rest of the group, and while maintaining compatibility with legacy IM/chat servers and clients.

Client-Side Implementation

According to one embodiment, the multiplexer/demultiplexer functionality described in the foregoing paragraphs is realized in conjunction with the client devices or software running on the client devices, such as a plug-in to a browser or IM client program.

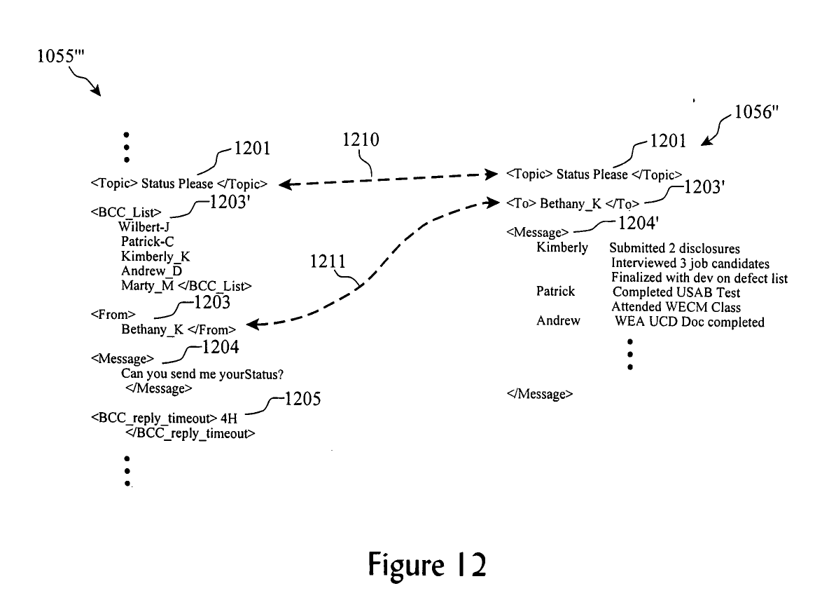

FIG. 11 illustrates such an implementation, wherein a browser, IM agent, or chat agent (1101) are provided with a functional extension, such as a plug-in or code modification, containing the logical processes of the BPRC Mux-Demux (1050, 1051). The apparent multi-party messages (1055′, 1056′) are exchanged between the BPRC Mux/Demux (1050, 1051) and the browser or agent (1101) locally, and the multiple two-party messages (1053, 1054) are exchanged between the BPRC Mux/Demux (1050, 1051) and a server (not shown in this diagram), typically over a communications network such as the Internet, a WAN, a wireless network, or the like.

Server-Side Implementation

According to one embodiment, the multiplexer/demultiplexer functionality described in the foregoing paragraphs is realized in conjunction with the IM/chat server or software running on the IM/chat server, such as a plug-in to an IM or chat server program or suite. In one embodiment, an extension to the IBM SameTime™ messaging software is provided.

FIG. 17 illustrates such an implementation, wherein an IM server suite (50) is provided with a functional extension, such as a plug-in or code modification, containing the logical processes of the BPRC Multiplexer/Demultiplexer (1050, 1051). The apparent multi-party messages (1055′, 1056′) are exchanged between the BPRC Mux/Demux (1056′, 1055′) and the primary client device (41) remotely such as via a communications network, and the multiple two-party messages (1053, 1054) are exchanged between the BPRC Mux/Demux (1050, 1051) and the IM server suite (50) locally.

User Interface for BPRC Message Authoring

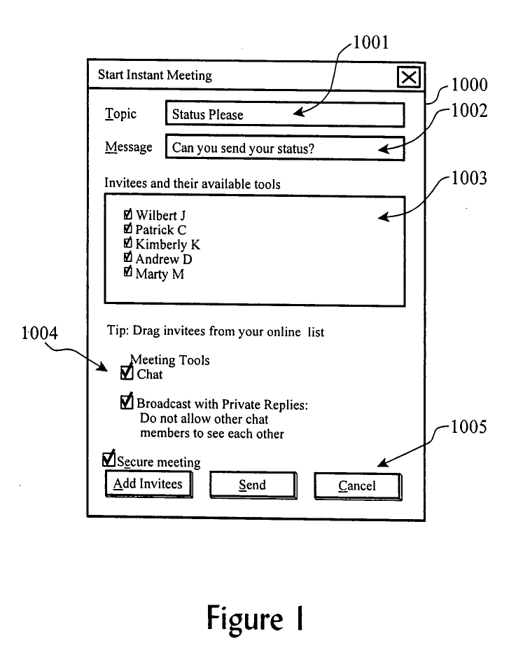

Turing to FIG. 1, a user interface according to the preferred embodiment is shown, which includes a graphical user interface (“GUI”) window (1000) or dialog box produced in a conventional manner on the screen or display of a client device. It includes form entry boxes, drop-down lists, or other conventional methods to allow the user to specify or select a topic (1001), the text of a message (1002), a list of group invitees (1003), and to enable BPRC chatting (1004), as well as usual selectable actions such as a “send” and “cancel” button (1005).

BPRC Message Controls and Format

It will be readily recognized by those skilled in the art that many message formats and control schemes may be adopted to realize the present invention. FIG. 12 illustrates one available message format which embeds the BPRC controls in an eXentisible Markup Language (“XML”) style data structures (1055″, 1056′″).

In this arrangement, the original message (1055″) includes a topic field (1201) and an author designation (e.g. “from” field) (1203), and includes a special designation of a plurality of BPRC group members (1202) to which the message (1204) should be sent, and from whom replies should only be routed to the author (1203). Optionally, a maximum time for waiting (1205) can also be specified so that the BPRC Mux/Demux function can determine how long to optionally wait for additional replies (if all parties have not already replied).

The consolidated simulated multi-party message (1056′″) is created by collecting the individual two-party group replies as previously described, and placing the text of those two-party messages in to a single message field (1204′) of the reply message (1056′″), preferrably annotated to indicate which user provided which reply text strings or lines (e.g. Kimberly, Patrick, Andrew, etc.). The consolidated simulated multi-party message (1056″) and the individual two-party replies are correlated to the original message (1055″) preferably using the author's indications (1211), and/or correlated (1210) by the topic fields (1201).

For example, as the reply “Submitted 2 disclosures<LF>Interviewed 3 job candidates<LF>Finalized with dev on defect list” is received from Kimberly in the two-party IM group consisting of Kimberly and Bethany, where <LF> indicates a line feed or carriage return, the BPRC Demux determines that the topic matches that of a recently sent message from Bethany_K, and places that message in a queue for merging with other BPRC replies.

Then, as the reply “Completed USAB test<LF>Attended WECM Class” is received from user “Patrick”, it too is correlated by topic and sender to the BPRC simulated multi-party group for Bethany_K, and is queued for merging with other BPRC replies.

Likewise, when a reply message from “Andrew” is received from a two-party IM group consisting of Andrew and Bethany, it is queued for merging, as well.

When the time for replies has elapsed (e.g. a timeout for replying has expired), or when all of the original recipients have replied, the message text from each of the queued replies is extracted and concatenated into the message field of a consolidated message (1056″), and the rest of the fields for the consolidated message are generated accordingly (e.g. topic, to, etc.). This unitary message, which appears to be from a multi-party IM/chat group, is then sent to the primary user (41) for display and further conversation.

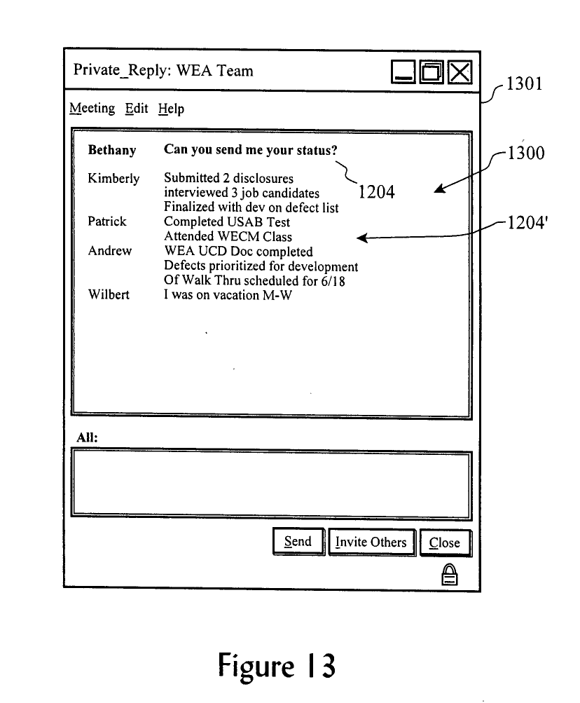

FIG. 13 illustrates such a consolidated simulated multi-party reply message, in which a GUI window or dialog box (1301) is provided a copy of the original message (1204), and the collected and concatenated reply messages (1204′).

Thus, a transparent conversion is accomplished between an original, unitary, multi-party IM/chat group message, to a plurality of two-party IM/chat group messages and corresponding replies, back to a unitary, consolidated simulated multi-party IM/chat group reply to the originator.

Logical Processes of the Invention

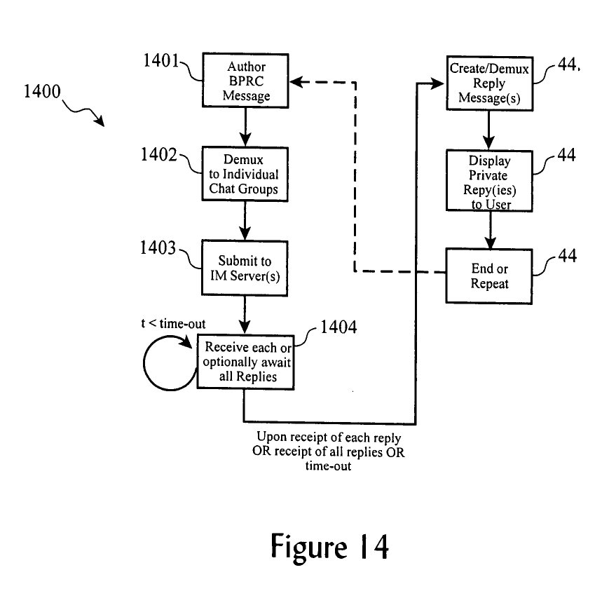

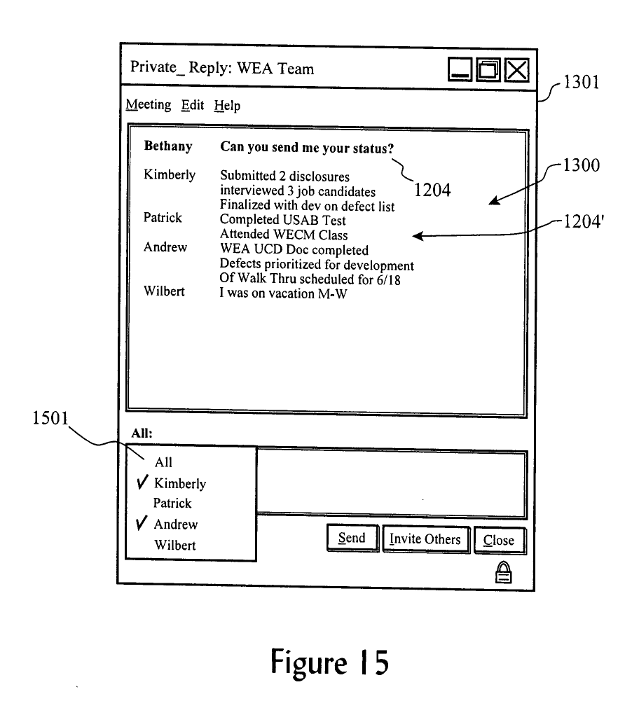

Turning to FIG. 14, a logical process (1400) according to the present invention is shown in which a BPRC message is authored (1401), then demultiplexed (1402) into a plurality of two-party IM/chat group messages which are submitted (1403) to a plurality of two-party IM/chat groups via a server.

The logical process then correlates and queues received two-party IM/chat group messages while waiting (1404) for a present duration or until all parties have replied, after which a unitary, simulated multi-party IM/chat group reply message is created (1405) and sent (1406) to the primary client.

The process can be repeated (1407) if the primary client decides to reply to the replies. For example, the user interface shown in FIG. 15 allows the primary user to select any or all of the original BPRC recipient list (1501) for receiving the next message (e.g. the reply to the replies).

Enhanced Embodiment Using BPRC Sub-Groups

According to another embodiment of the invention, the BPRC list of recipients can be further divided into sub-groups such that a reply from a member of a sub-group is automatically transmitted to the primary party and to the other parties in the same sub-group, but is not transmitted to the members of other sub-groups. This enhanced functionality allows even greater control by the primary user in the dissemination and flow of information.

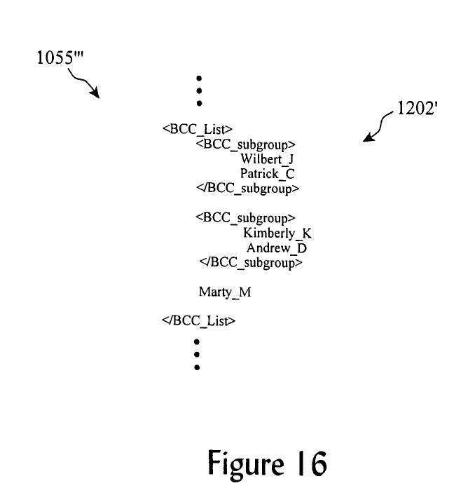

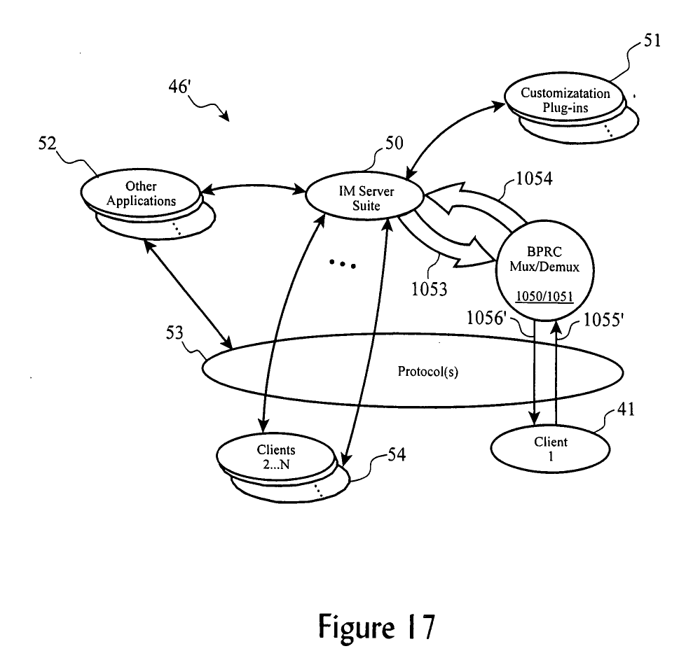

To accomplish this, when the invention determines when a sub-group (1202′) is indicated in the original message, such as shown in FIG. 16. If a sub-group is found, then a reduced multi-party IM/chat group is utilized with the IM server (46) instead of a set of two-party IM/chat groups. In the example shown in FIG. 16, the entire multi-party group would normally consist of the primary user, Bethany, with five other members, Wilbert, Patrick, Kimberly, Andrew and Marty. Using the invention as previously described (without sub-groups), the original message would be directed towards five different two-party IM/chat groups, namely:
(a) Bethany and Wilbert;
(b) Bethany and Patrick;
(c) Bethany and Kimberly;
(d) Bethany and Andrew; and
(e) Bethany and Marty.

However, using sub-groups as indicated in the example of FIG. 16, the following reduced multi-party IM/chat groups would be utilized:
(a) Bethany, Wilbert and Patrick;
(b) Bethany, Kimberly, and Andrew;

as well as one two-party IM/chat group:
(c) Bethany and Marty.

In this enhanced embodiment of the invention, when Bethany's original message is replied to by Patrick, it would be sent to Bethany (the primary user or originator) as well as to Wilbert, but not to Kimberly, Andrew or Marty. Likewise, a reply sent by Andrew would be copied to Kimberly and Bethany, but not to Wilbert, Patrick or Marty. A reply sent by Marty would only be copied to Bethany.

Suitable Computing Platform

The invention is preferably realized as a feature or addition to the software already found present on well-known computing platforms such as personal computers, web servers, and web browsers. These common computing platforms can include personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

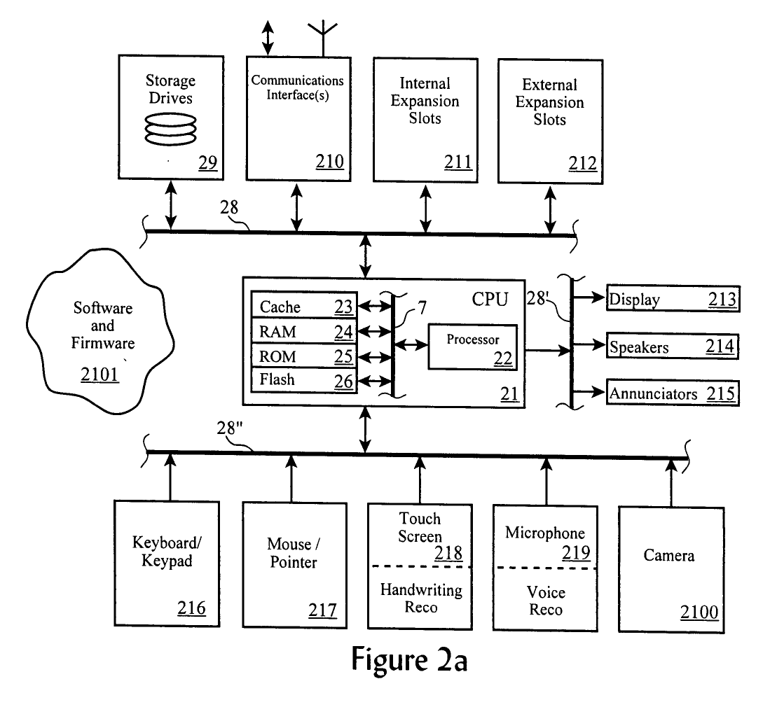

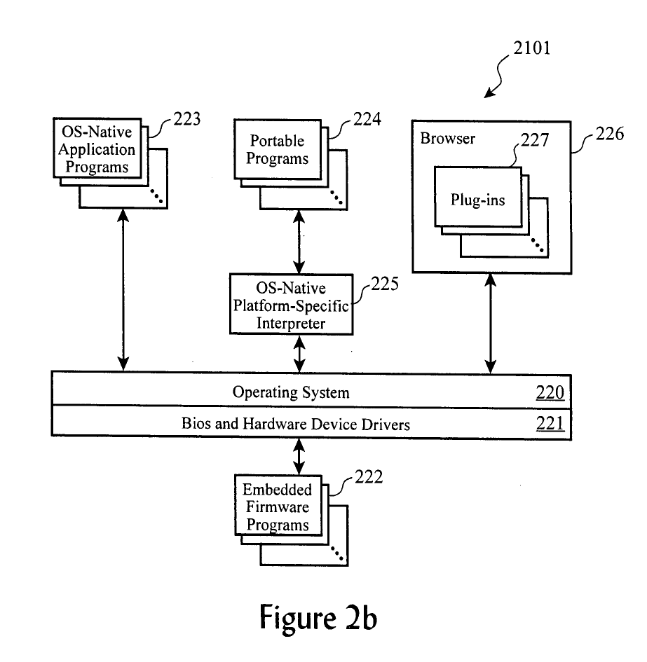

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as a hard-disk drives (“HDD”), floppy disk drives, compact disc drives (CD, CD-R, CD-RW, DVD, DVD-R, etc.), and proprietary disk and tape drives (e.g., Iomega Zip™ and Jaz™, Addonics SuperDisk™, etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc.

The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java™ scripts and programs.

Often, computing platforms are also provided with a form of web browser or micro-browser (226), which may also include one or more extensions to the browser such as browser plug-ins (227).

The computing device is often provided with an operating system (220), such as Microsoft Windows™, UNIX, IBM OS/2™, IBM AIX™, open source LINUX, Apple's MAC OS™, or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

Software Deployment

According to one embodiment of the invention, the methods and processes of the invention are distributed or deployed as a service to by a service provider to a client's computing system(s).

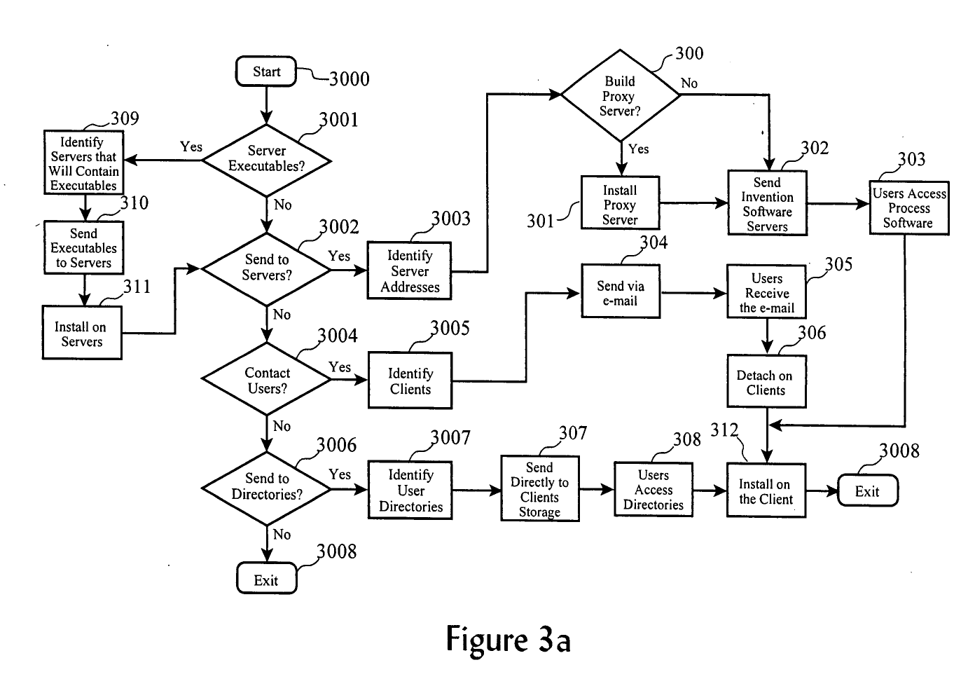

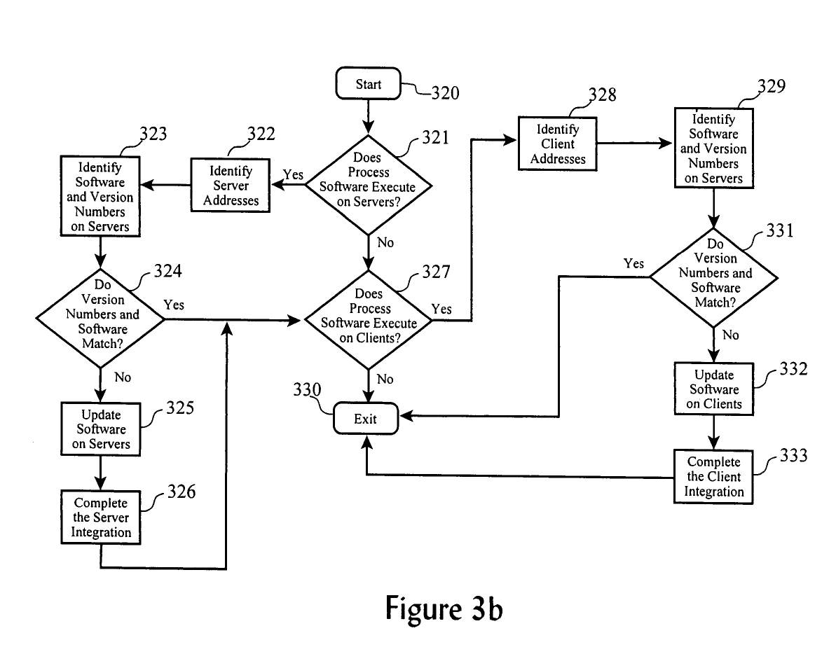

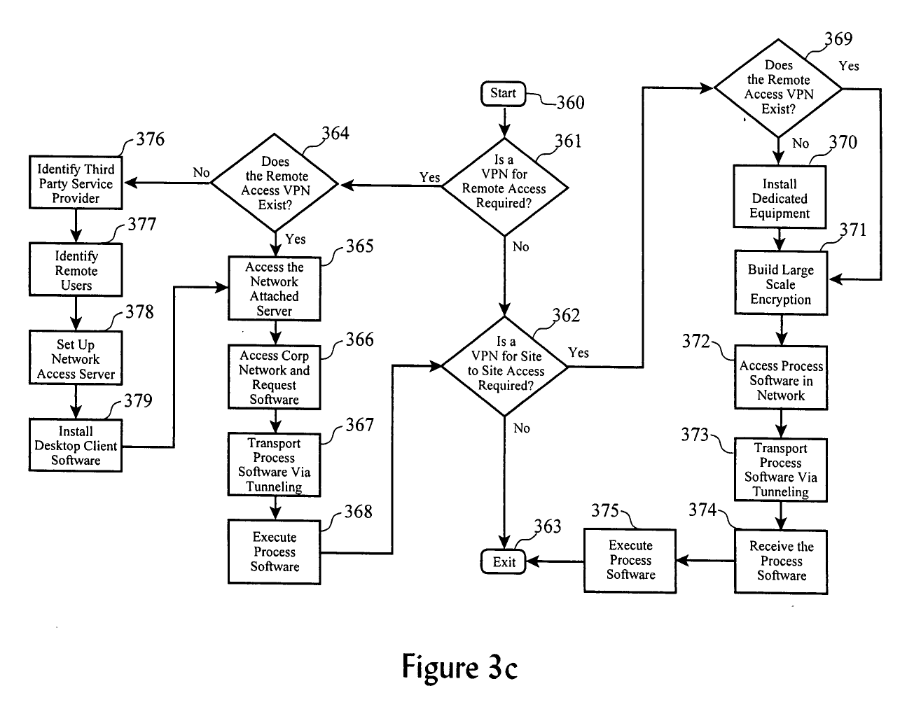

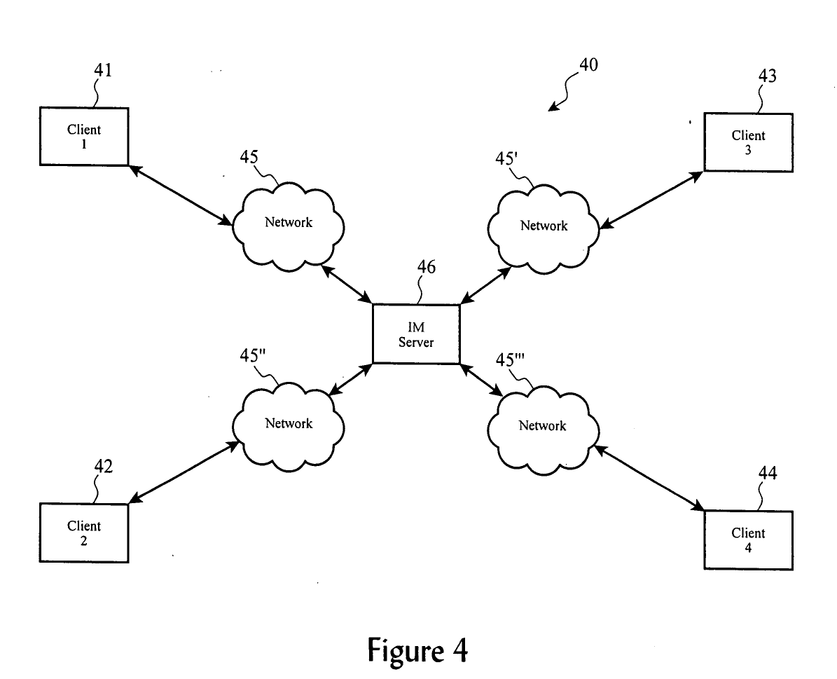

Turning to FIG. 3a, the deployment process begins (3000) by determining (3001) if there are any programs that will reside on a server or servers when the software is executed. If this is the case then the servers that will contain the executables are identified (309). The appropriate software for the server or servers is transferred directly to the servers storage via FTP or some other protocol or by copying through the use of a shared files system (310). The appropriate software is then installed on the servers (311).

Next a determination is made on whether the appropriate software is to be deployed by having users access the software on a server or servers (3002). If the users are to access the software on servers then the server addresses that will store the software are identified (3003).

In step (3004) a determination is made whether the software is to be developed by sending the software to users via e-mail. The set of users where the software will be deployed are identified together with the addresses of the user client computers (3005). The software is sent via e-mail to each of the user's client computers. The users then receive the e-mail (305) and then detach the software from the e-mail to a directory on their client computers (306). The user executes the program that installs the software on his client computer (312) then exits the process (3008).

A determination is made if a proxy server is to be built (300) to store the software. A proxy server is a server that sits between a client application, such as a Web browser, and a destination server. It intercepts all requests to the destination server to see if it can fulfill the requests itself. If not, it forwards the request to the destination server. The two primary benefits of a proxy server are to improve performance and to filter requests. If a proxy server is required then the proxy server is installed (301). The software is sent to the servers either via a protocol such as FTP or its copied directly from the source files to the server files via file sharing (302). Another embodiment would be to send a transaction to the servers that contained the software and have the server process the transaction, then receive and copy the software to the server's file system. Once the software is stored at the servers, the users via their client computers, then access the software on the servers and copy to their client computers file systems (303). Another embodiment is to have the servers automatically copy the software to each client and then run the installation program for the software at each client computer. The user executes the program that installs the software on his client computer (312) then exits the process (3008).

Lastly, a determination is made on whether the software will be sent directly to user directories on their client computers (3006). If so, the user directories are identified (3007). The software is transferred directly to the user's client computer directory (307). This can be done in several ways such as but not limited to sharing of the file system directories and then copying from the sender's file system to the recipient user's file system or alternatively using a transfer protocol such as File Transfer Protocol (“FTP”). The users access the directories on their client file systems in preparation for installing the software (308). The user executes the program that installs the software on his client computer (312) then exits the process (3008).

Software Integration

According to another embodiment of the present invention, software embodying the methods and processes disclosed herein are integrated as a service by a service provider to other software applications, applets, or computing systems.

Integration of the invention generally includes providing for the BPRC software to coexist with applications, operating systems and network operating systems software and then installing the BPRC software on the clients and servers in the environment where the BPRC software will function.

Generally speaking, the first task is to identify any software on the clients and servers including the network operating system where the BPRC software will be deployed that are required by the BPRC software or that work in conjunction with the BPRC software. This includes the network operating system that is software that enhances a basic operating system by adding networking features. Next, the software applications and version numbers will be identified and compared to the list of software applications and version numbers that have been tested to work with the BPRC software. Those software applications that are missing or that do not match the correct version will be upgraded with the correct version numbers. Program instructions that pass parameters from the BPRC software to the software applications will be checked to ensure the parameter lists matches the parameter lists required by the BPRC software. Conversely parameters passed by the software applications to the BPRC software will be checked to ensure the parameters match the parameters required by the BPRC software. The client and server operating systems including the network operating systems will be identified and compared to the list of operating systems, version numbers and network software that have been tested to work with the BPRC software. Those operating systems, version numbers and network software that do not match the list of tested operating systems and version numbers will be upgraded on the clients and servers to the required level.

After ensuring that the software, where the BPRC software is to be deployed, is at the correct version level that has been tested to work with the BPRC software, the integration is completed by installing the BPRC software on the clients and servers.

Turning to FIG. 3b, details of the integration process according to the invention are shown. Integrating begins (320) by determining if there are any BPRC software programs that will execute on a server or servers (321). If this is not the case, then integration proceeds to (327). If this is the case, then the server addresses are identified (322). The servers are checked to see if they contain software that includes the operating system (“OS”), applications, and network operating systems (“NOS”), together with their version numbers, that have been tested with the BPRC software (323). The servers are also checked to determine if there is any missing software that is required by the BPRC software (323).

A determination is made if the version numbers match the version numbers of OS, applications and NOS that have been tested with the BPRC software (324). If all of the versions match and there is no missing required software the integration continues in (327).

If one or more of the version numbers do not match, then the unmatched versions are updated on the server or servers with the correct versions (325). Additionally if there is missing required software, then it is updated on the server or servers (325). The server integration is completed by installing the BPRC software (326).

Step (327) which follows either (321), (324), or (326) determines if there are any programs of the BPRC software that will execute on the clients. If no BPRC software programs execute on the clients the integration proceeds to (330) and exits. If this is not the case, then the client addresses are identified (328).

The clients are checked to see if they contain software that includes the operating system (“OS”), applications, and network operating systems (“NOS”), together with their version numbers, that have been tested with the BPRC software (329). The clients are also checked to determine if there is any missing software that is required by the BPRC software (329).

A determination is made if the version numbers match the version numbers of OS, applications and NOS that have been tested with the BPRC software 331. If all of the versions match and there is no missing required software, then the integration proceeds to (330) and exits.

If one or more of the version numbers do not match, then the unmatched versions are updated on the clients with the correct versions (332). In addition, if there is missing required software then it is updated on the clients (332). The client integration is completed by installing the BPRC software on the clients (333). The integration proceeds to (330) and exits.

VPN Deployment

According to another aspect of the present invention, the methods and processes described herein may be embodied in part or in entirety in software which can be deployed to third parties as part of a service, wherein a third party virtual private network (“VPN”) service is offered as a secure deployment vehicle or wherein a VPN is build on-demand as required for a specific deployment.

A VPN is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the BPRC software (i.e. the software resides elsewhere) wherein the lifetime of the VPN is limited to a given period of time or a given number of deployments based on an amount paid.

The BPRC software may be deployed, accessed and executed through either a remote-access or a site-to-site VPN. When using the remote-access VPNs the BPRC software is deployed, accessed and executed via the secure, encrypted connections between a company's private network and remote users through a third-party service provider. The enterprise service provider (“ESP”) sets a network access server (“NAS”) and provides the remote users with desktop client software for their computers. The telecommuters can then dial a toll-free number to attach directly via a cable or DSL modem to reach the NAS and use their VPN client software to access the corporate network and to access, download and execute the BPRC software.

When using the site-to-site VPN, the BPRC software is deployed, accessed and executed through the use of dedicated equipment and large-scale encryption that are used to connect a companies multiple fixed sites over a public network such as the Internet.

The BPRC software is transported over the VPN via tunneling which is the process of placing an entire packet within another packet and sending it over the network. The protocol of the outer packet is understood by the network and both points, called tunnel interfaces, where the packet enters and exits the network.

Turning to FIG. 3c, VPN deployment process starts (360) by determining if a VPN for remote access is required (361). If it is not required, then proceed to (362). If it is required, then determine if the remote access VPN exits (364).

If a VPN does exist, then the VPN deployment process proceeds (365) to identify a third party provider that will provide the secure, encrypted connections between the company's private network and the company's remote users (376). The company's remote users are identified (377). The third party provider then sets up a network access server (“NAS”) (378) that allows the remote users to dial a toll free number or attach directly via a broadband modem to access, download and install the desktop client software for the remote-access VPN (379).

After the remote access VPN has been built or if it has been previously installed, the remote users can access the BPRC software by dialing into the NAS or attaching directly via a cable or DSL modem into the NAS (365). This allows entry into the corporate network where the BPRC software is accessed (366). The BPRC software is transported to the remote user's desktop over the network via tunneling. That is the BPRC software is divided into packets and each packet including the data and protocol is placed within another packet (367). When the BPRC software arrives at the remote user's desktop, it is removed from the packets, reconstituted and then is executed on the remote users desktop (368).

A determination is made to see if a VPN for site to site access is required (362). If it is not required, then proceed to exit the process (363). Otherwise, determine if the site to site VPN exists (369). If it does exist, then proceed to (372). Otherwise, install the dedicated equipment required to establish a site to site VPN (370). Then build the large scale encryption into the VPN (371).

After the site to site VPN has been built or if it had been previously established, the users access the BPRC software via the VPN (372). The BPRC software is transported to the site users over the network via tunneling. That is the BPRC software is divided into packets and each packet including the data and protocol is placed within another packet (374). When the BPRC software arrives at the remote user's desktop, it is removed from the packets, reconstituted and is executed on the site users desktop (375). Proceed to exit the process (363).

### CONCLUSION

The present invention has been set forth using a number of examples for illustration. It will be readily recognized by those skilled in the art that these examples do not represent the entire scope of the present invention, and that certain changes, modifications, and substitutions may be made in the selection of components, programming methodologies, computing platforms, and protocols, without departing from the spirit and scope of the present invention. Therefore, the scope of the invention should be determined by the following claims.

What is claimed is:

1. A method for controlling the flow of reply messages cooperative with a multi-party messaging service, said method comprising the steps of:
setting by a primary author a broadcast-with-private-reply control associated with a primary message having a text portion, a primary author indication portion, and a recipient list containing a plurality of user indicators to who said primary message is to be delivered;
demultiplexing said primary message by converting into a plurality of reduced multi-party messages, wherein each of said reduced multi-party messages are addressed to a sub-group of said recipient list;
submitting said reduced multi-party messages to at least one messaging service; and
multiplexing a plurality of reply messages by receiving one or more reduced multi-party reply messages from said messaging service, correlating said reply messages to said submitted message, and delivering said reply messages exclusively to said primary author, thereby keeping said reply messages private between each replying party and said primary author.

2. The method as set forth in claim 1 wherein step of demultiplexing comprises converting to at least one two-party message for a group consisting of said primary author and only one party from said recipient list.

3. The method as set forth in claim 1 wherein said step of demultiplexing consists of a converting to plurality messages addressed to two-party groups, wherein said two-party groups consist of said primary author and one party from said recipient list.

4. The method as set forth in claim 1 further comprising generating a consolidated reply message by queuing said received reduced multi-party reply messages, extracting reply message text from said queued messages, and generating a unitary simulated multi-party reply message containing said extracted reply message text for display to said primary author.

5. The method as set forth in claim 4 wherein said step of multiplexing further comprises waiting to receive said reply messages for a predetermined time.

6. The method as set forth in claim 1 wherein said step of submitting said primary message comprises submitting to an instant messaging service.

7. The method as set forth in claim 1 wherein said step of submitting said primary message comprises submitting to an online transaction processing, service.

8. The method as set forth in claim 1 wherein said step of submitting said primary message comprises submitting to an enterprise transaction handling environment.

9. The method as set forth in claim 1 wherein said step of submitting said primary message comprises submitting to an electronic mail system.

10. The method as set forth in claim 1 further comprising providing a client-side software extension for providing said demultiplexer, and multiplexer.

11. The method as set forth in claim 10 wherein said software extension comprises a client plug-in.

12. The method as set forth in claim 1 further comprising providing a server-side software extension for providing said demultiplexer, and multiplexer.

13. The method as set forth in claim 12 wherein said software extension comprises a server plug-in.

14. The method as set forth in claim 1 further comprising deploying and using a virtual private network for controlling the flow of private reply messages responsive to a broadcast message in a messaging system, comprising:
responsive to determining if remote access to broadcast-with-private-reply software, transmitting said software to a client via an unsecure network using secure tunneling;
responsive to determining if site access to said software is required, transmitting said software to a client via an unsecure network using secure tunneling; and
executing said software by said client to perform said steps of setting a broadcast-with-private-reply control associated with a primary message, demultiplexing said primary message, submitting said reduced multi-party messages to at least one messaging service, and multiplexing a plurality of reply messages.

15. A system for controlling the flow of reply messages cooperative with a multi-party messaging service, said system comprising:
a primary message having a text portion, a primary author indication portion, a broadcast-with-private-reply control set to an enabled state by said primary author, and a recipient list containing a plurality of user indicators to who said primary message is to be delivered;
a demultiplexer adapted to convert said primary message into a plurality of reduced multi-party messages, wherein each of said reduced multi-party messages are addressed to a sub-group of said recipient list;
a message submitter adapted to submit said reduced multi-party messages to at least one messaging service; and
a multiplexer for receiving one or more reduced multi-party reply messages from said messaging service, correlating said reply messages to said submitted message, and delivering said reply messages exclusively to said primary author, thereby keeping said reply messages private between each replying party and said primary author.

16. The system as set forth in claim 15 wherein said reduced multi-party messages comprise at least one two-party group, each of said two-party group consisting of said primary author and one party from said recipient list, and said system further comprising a reply message generator adapted to queue said received reduced multi-party reply messages, to extract reply message text from said queued messages, and to generate a unitary simulated multi-party reply message containing said extracted reply message text for display to said primary author.

17. The system as set forth in claim 16 wherein said reduced multi-party messages consist exclusively of a plurality of two-party groups, wherein said two-party groups comprises said primary author and one party from said recipient list.

18. A computer-readable medium encoded with software for controlling the flow of reply messages cooperative with a multi-party messaging service, said software adapted to perform the steps of:
setting by a primary author a broadcast-with-private-reply control associated with a primary message having a text portion, a primary author indication portion, and a recipient list containing a plurality of user indicators to who said primary message is to be delivered;
demultiplexing said primary message by converting into a plurality of reduced multi-party messages, wherein each of said reduced multi-party messages are addressed to a sub-group of said recipient list, at least one of said reduced multi-party messages being a two-party message addressed to said primary author and only one party from said recipient list;
submitting said reduced multi-party messages to at least one messaging service; and
multiplexing a plurality of reply messages by receiving one or more reduced multi-party reply messages from said messaging service, correlating said reply messages to said submitted message, and delivering said reply messages exclusively to said primary author, thereby keeping said reply messages private between each replying party and said primary author.

19. The computer readable medium as set forth in claim 18 wherein said software for demultiplexing consists of a converting to plurality messages addressed to two-party groups, wherein said two-party groups consist of said primary author and one party from said recipient list.

20. The computer readable medium as set forth in claim 18 further comprising software for generating a consolidated reply message by queuing said received reduced multi-party reply messages, extracting reply message text from said queued messages, and generating a unitary simulated multi-party reply message containing said extracted reply message text for display to said primary author.
